(19) United States
(12) Patent Application Publication
(10) Pub. No.: US 2003/0012719 A1
(43) Pub. Date: Jan. 16, 2003

(54) Catalyst and process for removing carbon monoxide from a reformate gas

(75) Inventors: Meike Roos, Biebergemund (DE); Frank Adam, Freigericht (DE); Frank Baumann, Alzenau (DE); Stefan Andersch, Freigericht (DE); Stefan Wieland, Offenbach (DE)

Correspondence Address: KALOW & SPRINGUT LLP, 488 MADISON AVENUE, 19TH FLOOR, NEW YORK, NY, 10022, US

(73) Assignee: OMG AG & Co. KG, Hanau (DE)

(21) Appl. No.: 10/120,277

(22) Filed: Apr. 10, 2002

(30) Foreign Application Priority Data
Apr. 14, 2001 (EP) 01 109 243.4

(51) Int. Cl. B01J 23/56

(52) U.S. Cl. 423/247; 502/330; 502/303; 502/304

(57) ABSTRACT

The invention provides a catalyst for removing carbon monoxide from a reformate gas. The catalyst is characterized in that it contains gold and ruthenium in a ratio by weight between 5:1 and 1:5 on a support material of aluminum oxide, titanium oxide, zirconium oxide, cerium oxide, lanthanum oxide and mixtures or mixed oxides thereof.

### FIELD OF THE INVENTION

This invention relates to a methods for preparing a catalyst and a process for removing carbon monoxide from a reformate gas.

### BACKGROUND OF THE INVENTION

To reduce emissions from internal combustion engines, efforts are being made to replace internal combustion engines by an electrical drive unit, wherein the electrical energy required for this purpose is intended to be provided by fuel cells. Polymer electrolyte fuel cells (PEM fuel cells) which are operated using hydrogen as the fuel are favored as sources of energy. It is intended to produce the hydrogen required on board the vehicle by steam reforming of gasoline, diesel fuel, methanol or other hydrocarbons.

Reformate gases contain, apart from the desired hydrogen, also carbon monoxide, carbon dioxide and water vapor. Carbon monoxide is toxic to the platinum catalysts used in fuel cells and therefore has to be removed as much as possible from the reformate, in several purification steps. Therefore, after the actual steam reforming stage, the reformate is usually subjected first to a high temperature shift (MTS) step and then to a low temperature shift (LTS) step. The reformate usually emerges from this step with a carbon monoxide concentration of about 1 vol. % and at a temperature of between 200 and 250° C.

The residual CO concentration of the reformate after the LTS step has to be reduced further because platinum/ruthenium catalysts can only tolerate concentrations of about 100 vol.ppm of carbon monoxide. Therefore, efforts are made to keep the residual CO concentrations in the reformate below 50 vol.ppm. In order to achieve this objective, the process of preferential oxidation (PROX) has often been suggested. According to this process, the carbon monoxide is selectively oxidized to carbon dioxide on a catalyst. An important parameter for preferential oxidation is the so-called normalized air/fuel ratio λ. This is the molar O₂/CO ratio, normalized to stoichiometric conditions. When the reaction mixture has a stoichiometric composition the normalized air/CO ratio λ=1. The reaction mixture then contains 1 mole of oxygen and 2 moles of carbon monoxide, that is λ can be calculated from the molar proportions in the reaction mixture as follows:

$$λ = 2 \cdot \frac{x mole {O}_{2}}{y mole C O} ,$$

wherein x is the number of moles of oxygen and y is the number of moles of CO in the reaction mixture.

It has been known that the activity of highly disperse gold on oxidic support materials for the oxidation of carbon monoxide is high, while at the same time the activity for the oxidation of hydrogen is low. However, only a few tests have been disclosed which relate to the use of such catalyst systems for the removal of carbon monoxide from reformats gases which are provided as fuels for the supply of PEM fuel cells and where the residual CO concentrations should therefore not exceed 50 vol.ppm.

The tests which have been disclosed were mostly performed with gas mixtures which produce only an approximate methanol reformate. They are generally gas mixtures with about 75 vol. % hydrogen, 1 vol. % carbon monoxide and 1 to 2.5 vol. % oxygen in a nitrogen matrix. Although tests in such gas mixtures can provide mechanistic and kinetic information on the mode of functioning of the catalyst, they enable hardly any conclusions to be drawn about the behavior of a corresponding catalyst during the preferential oxidation of carbon monoxide in real reformate gases, which always also contain carbon dioxide and water vapor. Due to the carbon dioxide content of real reformats gases a reverse water gas shift reaction can take place which leads to the formation of carbon monoxide and water with the consumption of hydrogen.

According to these tests, catalysts of highly disperse gold on transition metal oxides such as, for example, manganese oxide, titanium oxide, cobalt oxide, nickel oxide and α-Fe₂O₃ in the temperature range below 0° C. exhibit the complete conversion of CO to CO₂. At temperatures above 0° C., the oxidation of hydrogen occurs in competition with CO oxidation, which is particularly undesirable during the removal of CO from reformate gases. In addition, at a working temperature of 80° C., in particular for the Au/α-Fe₂O₃ system, a reverse water gas shift reaction is observed, that is an increase in the CO concentration due to reaction of the desired reaction product CO₂ with the hydrogen which is present in large amounts to give water and CO. The high variability in the working temperature range of these catalyst systems can be controlled to a certain extent by the choice of preparation conditions: catalysts which are prepared by the co-precipitation of gold and transition metal oxide are suitable for use at low temperatures, while preparation by means of impregnation of a transition metal oxide with a gold solution, followed by calcination, leads to catalysts which have the desired oxidation activity for CO at temperatures above 60° C.

When removing CO from reformate gases for the supply of fuel to PEM fuel cells, the optimum working point of the catalyst provided has to be governed by the intended area of use of the PROX reactor. There are two options here: on the one hand it is possible that the PROX reactor is located downstream of a low temperature water gas shift reactor which operates at temperatures of 200 to 300° C. In this case, the working temperature of the PROX catalyst should be between 180 and 250° C. None of the gold-containing catalyst systems described hitherto operate with adequate selectivity in this temperature range. On the other hand, insertion immediately upstream of the PEM fuel cell with a working temperature of 80° C. might be possible. Only the Au/α-Fe₂O₃ catalyst described above is suitable for this purpose. Residual CO concentrations of 30 vol.ppm are quoted for this catalyst. However, there is no reference to the residence time of the reaction gas on the catalyst.

Many prior art references disclose gold-containing catalyst with a transition metal oxide on an oxidic support for removing carbon monoxide from a reformate gas. For example, a bimetallic catalyst containing gold and a platinum group metal (Pd, Pt, Rh, Ru or Ir) with a mixed oxide based on cerium oxide for use as the support. But these prior art references do not provide key information such as, the selectivity of the catalyst in the presence of hydrogen, the temperature or conversion power during the oxidation of carbon monoxide, composition of the reformate gas and the space velocity . . . etc.

It is known in the art that although most gold-containing catalyst systems have a high activity for CO oxidation and a low activity for the oxidation of hydrogen, up to 60° C., the temperature ranges tested below 60° C. are far too low for applications for the preferential oxidation of CO for the purification of reformate gases for PEM fuel cell systems. Even direct coupling to a PEM fuel cell requires a working temperature of at least 80° C. However, gold catalysts are generally unselective in the required temperature range and they consume too much hydrogen if not becoming fully deactivated.

Ruthenium catalysts on oxidic support materials were developed primarily for use to remove CO from methanol reformate gases, wherein the selective methanisation of CO was used as a purification reaction in addition to the selective oxidation of CO. An example of the two step process is to first use the Ru/RuOₓ ruthenium catalysts on TiO₂/Al₂O₃ for selective methanization at temperatures of up to at most 200° C., while the subsequent selective oxidation of residual CO is performed, in a second step, on a platinum catalyst on TiO₂ and Al₂O₃. Using the combination of these two steps, residual CO concentrations of <50 vol.ppm are produced. Here, the use of a ruthenium catalyst for selective methanisation indicates that unwanted side reactions that consume hydrogen, have to be reckoned on in principle when using ruthenium catalysts for preferential oxidation.

The problem with using a ruthenium catalyst for selective methanisation is that undesirable side reactions occur to consume hydrogen when using ruthenium catalysts for preferential oxidation.

It has also been known in the art that although ruthenium catalysts on oxidic supports, in particular Al₂O₃, are basically suitable for removing CO from reformate gases at working temperatures of 80 to 120° C., or 180 to 250° C. (depending on the formulation), a loss of hydrogen due to the methanisation of CO always is a problem in the case of pure ruthenium.

Based on the forgoing there is a need in the art to provide a catalyst and a process for the removal of carbon monoxide from reformate gases which has a high activity and selectivity in a working temperature range between 80 and 120° C. (low-temperature PROX) and between 120 and 250° C. (high-temperature PROX).

### SUMMARY OF THE INVENTION

The present invention provides a catalyst for removing carbon monoxide from a reformate gas. Accordingly, the catalyst comprises of gold and ruthenium in a ratio by weight between 5:1 and 1:5 on a support material of aluminum oxide, titanium oxide, zirconium oxide, cerium oxide, lanthanum oxide and mixtures or mixed oxides thereof.

The present invention also provides a process for removing carbon monoxide from a reformate gas by passing the reformate gas over the gold/ruthenium catalyst with a space velocity of 5,000 to 200,000 h⁻¹ at a temperature between 100 and 250° C. and the normalized air to fuel ratio of the reformate prior to contact with the catalyst is increased to a value between 1 and 10 by supplying oxygen.

For a better understanding of the present invention together with other and further advantages and embodiments, reference is made to the following description taken in conjunction with the examples, the scope of which is set forth in the appended claims.

### BRIEF DESCRIPTION OF THE FIGURE

Preferred embodiments of the invention have been chosen for purposes of illustration and description, but are not intended in any way to restrict the scope of the invention. The preferred embodiments of certain aspects of the invention is shown in the accompanying figure, wherein:.

FIG. 1 is a comparative graphic illustration of performance curves for ruthenium/gold catalysts with a gaseous hourly space velocity of 10,000/h. Pressure of 2 bars and the normalized air to fuel ratio equal to 4.

### DETAILED DESCRIPTION OF THE INVENTION

The invention will now be described in connection with preferred embodiments. These embodiments are presented to aid in an understanding of the present invention and are not intended to, and should not be construed to, limit the invention in any way. All alternatives, modification and equivalents which may become obvious to those of ordinary skill on reading the disclosure are included within the spirit and scope of the present invention.

This disclosure is not a primer on the methods of preparing a ruthenium/gold catalyst and a process for removing carbon monoxide from a reformate gas.

Using the combination of properties of ruthenium and gold as catalytically active components on a suitable support material, it has been possible to adjust catalysts for the preferential oxidation of CO specifically to the corresponding desired working temperature range (80 to 120° C. for low-temperature PROX and 180 to 250° C. for high-temperature PROX).

Aluminum oxide is particularly suitable as a support material for the catalyst. An active aluminum oxide with a specific surface area of more than 50 m²/g is advantageous. The loading of this support material with gold and ruthenium is preferably in the range between 0.1 and 10 wt. %, with respect to the total weight of catalyst. It was found that the optimum range of working temperature can be shifted by the extent of loading of the support material with gold and ruthenium. The higher the loading, the more the temperature range is shifted to lower temperatures. However, the catalytic properties of the catalyst are very slightly impaired with increasing loading. It was found that this trend can be counteracted when, as support material, an additional 1 to 10 wt. % of titanium dioxide, with respect to the total weight of support material, is present as a physical mixture with the aluminum oxide.

The catalyst according to the invention can be processed to give tablets or extrudates. Preferably, however, it is applied to an inert carrier body in the form of a coating. Suitable inert carrier bodies are honeycomb monoliths of ceramic or metal, open-cell, ceramic or metallic expanded materials, metal sheeting, heat exchanger plates or irregularly shaped structural parts.

For this purpose, the support material present in powder form is suspended in water. To improve adhesion to the intended carrier body, a binder may be added to the suspension. The particle size of the solids in suspension is then adjusted to a value between 2 and 10 μm by milling.

The carrier body can be coated, for example, by immersion in the suspension with the support material. The concentration of coating on the carrier body should preferably be between 30 and 150 g/l volume of carrier body. After drying and calcining the coating, it can be impregnated with the catalytically active components by immersion in a solution of precursor compounds of gold and ruthenium. Suitable precursor compounds of gold and ruthenium are, for example, tetrachloroauric acid and ruthenium trichloride.

Drying the fresh coating on the carrier body normally takes place at elevated temperature between 80 and 200° C. Subsequent calcination of the coating takes place at temperatures between 300 and about 600° C. The calcination time should be between 1 and 10 hours. In order to avoid thermal shock, calcination may also be performed in several steps at increasing temperatures. The form of the actual calcination conditions used has only a negligible effect on the activity of the ultimate catalyst so they only have to comply with the requirements for producing a firmly adhering coating. Calcination after impregnation of the coating with catalytically active components can also be varied over a wide range, as long as the temperature during calcination does not substantially exceed a value of 600° C. The maximum temperature of 600° C. ensures that the oxide coating and also the catalytically active components are not damaged by thermal effects. The final reduction process can also be performed within a wide temperature range, between 300 and 600° C. A reduction temperature of 500° C. for a period of 3 to 5 hours has proven suitable.

Suitable carrier bodies for the catalytic coating are also the honeycomb monoliths made of ceramic (for example cordierite) or metal and known from car exhaust gas catalysis. These honeycomb monoliths are traversed by parallel flow channels for the reaction gas. The density of these channels over the cross-section of the honeycomb monolith is called the cell density. Honeycomb monoliths with cell densities between 50 and 100 cm⁻² are preferably used.

Obviously, corresponding catalysts can also be prepared on other oxidic carrier bodies, e.g. Al₂O₃ pellets.

Al₂O₃ pellets or extrudates which are optionally preimpregnated with a titanium solution, calcined and then impregnated with noble metal solution, calcined and reduced can be used, wherein the concentration of the optional titanium doping and of the catalytically active noble metal have to be reduced because such pellet catalysts are shell catalysts. The actual concentrations are then governed by the thickness of the shell which, for its part, depends on whether and how the Al₂O₃ pellets have been pretreated.

Basically, when using pellet catalysts, account must be taken of the fact that the flow conditions, and thus also the reaction conditions, in a fixed bed packing are fundamentally different from those in a monolithic catalyst. For applications in the production and purification of hydrogen for a fuel cell system, therefore, the use of monoliths or carrier bodies with other geometries having defined flow channels is preferred.

The catalyst according to the invention is especially suitable for the removal of carbon monoxide from reformate gases from a variety of sources (methanol reformate, petrol reformate or diesel reformate). The reformate is passed over the catalyst with a space velocity of 5,000 to 200,000 h⁻¹ at a temperature between 100 and 250° C. The normalized air to fuel ratio of the reformate prior to contact with the catalyst is raised to a value between 1 and 10 by supplying oxygen.

The process is preferably performed in several steps, wherein the supply of oxygen upstream of each catalyst step is regulated so that the normalized air to fuel ratio increases with decreasing concentration of carbon monoxide in the reformate and the normalized air to fuel ratio averaged over all the process steps is between 1.2 and 4.0. The normalized air to fuel ratio in the first process step is preferably chosen to be 1.

Having now generally describe the invention, the same may be more readily understood through the following reference to the following single figure and the examples, which are provided by way of illustration and are not intended to limit the present invention unless specified.

### EXAMPLES

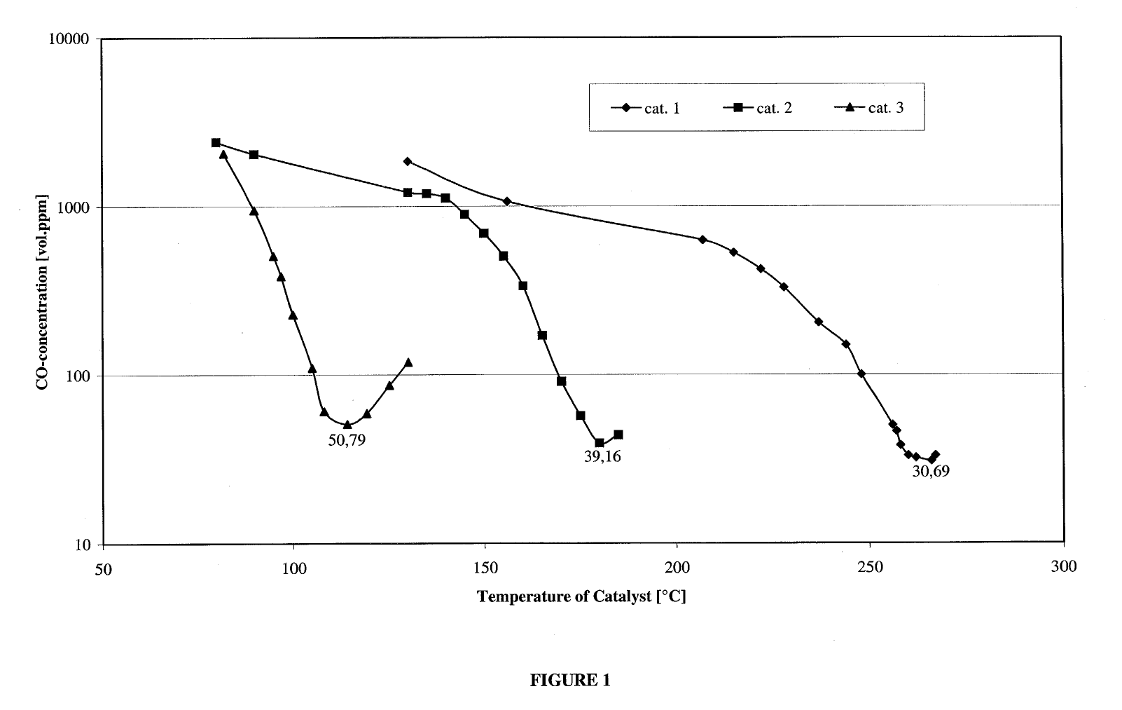

Honeycomb monoliths made of cordierite with a cell density of 93 cm⁻² were used as carrier bodies for the catalysts in the following examples. In Examples 1-3, FIG. 1 shows the performance curves for Ru/Au catalysts with a gaseous hourly space velocity (GHSV) of 10000/h, a pressure of 2 bar and a normalized air to fuel ratio of 4.

### Example 1

To prepare a catalyst according to the invention (cat. 1), active aluminum oxide with a specific surface area of 140 m²/g was suspended in water and homogenized to a particle size of 3 to 10 μm by milling. The coating suspension formed in this way had a solids content of 30 wt. %.

This coating suspension was then deposited on a monolithic honeycomb made of cordierite. The loading on the honeycomb monolith, after drying and calcination of the coating, was 75 g/l of honeycomb monolith volume. After calcination at 500° C. for a period of 3 hours, the coating was impregnated by immersion of the honeycomb monolith in a solution of tetrachloroauric acid and ruthenium trichloride. Following renewed calcination, the catalyst was reduced in a forming gas (5 vol.−% H₂+95 vol.−% N₂) stream at a temperature of 500° C. for a period of 2 hours and then washed until chloride-free. The loading of catalyst with gold and ruthenium was 1.6 wt. % of each, with respect to the total weight of coating.

### Example 2

Another catalyst (cat. 2) was prepared in the same way as described in example 1. The final catalyst contained about double the concentration of gold and ruthenium (3.13 wt. % each).

### Example 3

Another catalyst (cat. 3) was prepared in the same way as described in example 1. The support material was a mixture of titanium dioxide and aluminum oxide. The oxide mixture contained 96 wt. % of the active aluminum oxide used in the preceding examples and 4 wt. % of titanium dioxide (anatase) with a specific surface area of 40 m²/g. The noble metal loading of the catalyst corresponded to that in example 1.

In Examples 1-3, all the catalysts were tested in a synthetic reformate stream with added oxygen which corresponded to a normalized air to fuel ratio λ=4 (56.26 vol. % H₂, 22.6 vol. % CO₂, 5.7 vol. % H₂O, 14.7 vol. % N₂, 2790 ppm CO, 5580 ppm O₂). The performance curves of the catalysts mentioned, with a space velocity GHSV =10,000 h⁻¹ and p=2 bar (abs.), are plotted in the single figure.

With cat. 1, residual CO concentrations in the reformate of 35 ppm and less were reached at operating temperatures from 260° C. The conversion at the optimum working point of 266° C. was 98.9%.

The loss of hydrogen due to methanisation and H₂ oxidation was determined by measuring the methane formed and the residual CO concentration in the product gas stream and converting the amount of O₂ consumed after preferential oxidation into an equivalent H₂ loss due to combustion of hydrogen. Taking safety factors into account when determining the methane concentration, only 1.8% of the hydrogen introduced was lost as a result of methanisation and H₂ oxidation.

With cat. 2, a CO conversion of 98.6% is achieved at an optimum working point of 180° C. The residual CO concentration in the reformate is then less than 40 ppm. 2.1% of the hydrogen introduced is lost as a result of methanisation and H₂ oxidation.

With the low-temperature catalyst cat. 3, the CO concentration in the reformate is reduced to 50 to 60 vol.ppm at 110 to 120° C. 1.5% of the hydrogen introduced is lost as a result of methanisation and H₂ oxidation.

While the invention has been described in connection with specific embodiments thereof, it will be understood that it is capable of further modifications and this application is intended to cover any variations, uses, or adaptations of the invention following, in general, the principles of the invention an including such departures from the present disclosure as come within known or customary practice within the prior art to which the invention pertains and as may be applied to the essential features hereinbefore set forth and as follows in the scope of appended claims.

What is claimed:

1. A catalyst for removing carbon monoxide from a reformate gas comprising gold and ruthenium in a ratio by weight of between about 5:1 and about 1:5 on a support material selected from the group consisting of aluminum oxide, titanium oxide, zirconium oxide, cerium oxide, lanthanum oxide and mixtures thereof.

2. A catalyst according to claim 1, wherein the support material is aluminum oxide with a specific surface area of greater than 50 m²/g.

3. A catalyst according to claim 2, wherein at least 1 to 10 wt. % of titanium dioxide based on the total weight of the support material, is in a physical mixture with the aluminum oxide as the support material.

4. A catalyst according to claim 2, wherein the catalyst contains 0.1 to 10 wt. % of gold and ruthenium based on the total weight of the catalyst.

5. A catalyst according to claim 1, wherein the catalyst is applied, in the form of a coating, to an inert carrier body.

6. A catalyst according to claim 5, wherein the inert carrier body is a honeycomb monolith made of material selected from the group consisting of ceramic, metal, open-cell, ceramic expanded materials, metallic expanded materials, metal sheeting and heat exchanger plates.

7. A process for providing a catalyst for removing carbon monoxide from a reformate gas comprising:
a. coating a carrier body with an aqueous suspension of support materials;
b. drying and calcining the coating;
c. impregnating the coating with gold and ruthenium using a solution of soluble precursor compounds; and
d. drying, calcining and reducing the gold and ruthenium containing coating to provide the catalyst for removing carbon monoxide from the reformate gas.

8. A process for removing carbon monoxide from a reformate gas by passing the reformate gas over a catalyst according to claim 1, comprising passing the reformate gas over the catalyst with a space velocity of between about 5,000 to about 200,000 h⁻¹ at a temperature between about 100 and about 250° C. and increasing normalized air to fuel ratio of the reformate gas prior to contact with the catalyst to a value between about 1 and about 10 by supplying oxygen.

9. A process according to claim 8, wherein the process is performed in several steps and the supply of oxygen upstream of each catalyst step is controlled so that the normalized air to fuel ratio increases with decreasing concentration of carbon monoxide in the reformate and the normalized air to fuel ratio averaged over all process steps is between 1.2 and 4.0.

10. A process according to claim 9, wherein the normalized air to fuel ratio in the first step is 1.
